(19) United States
(12) Patent Application Publication
(10) Pub. No.: US 2006/0150020 A1
(43) Pub. Date: Jul. 6, 2006

(54) Computer

(76) Inventors: Won-joo Lee, Hwaseong-si (KR); Hong-kil Park, Suwon-si (KR)

Correspondence Address: STANZIONE & KIM, LLP, 919 18TH STREET, N.W., SUITE 440, WASHINGTON, DC, 20006, US

(21) Appl. No.: 11/294,402

(22) Filed: Dec. 6, 2005

(30) Foreign Application Priority Data
Dec. 22, 2004 (KR) 2004-110609

(51) Int. Cl. G06F 11/00

(52) U.S. Cl. 714/36

(57) ABSTRACT

The present general inventive concept relates to a computer having a network part to transmit and receive data through a network; a data storage to store downloaded data received through the network part, a mode selector to select one of a first download mode and a second download mode, a first download manager to control the data storage to store the downloaded data received through the network part when the first download mode is selected by the mode selector, and a second download manager to control the data storage to store the downloaded data received through the network part when the second download mode is selected by the mode selector. Thus, a computer capable of switching to a power save mode while the computer downloads data through a network is provided, so that a power consumption is reduced.

### CROSS-REFERENCE TO RELATED APPLICATIONS

This application claims the benefit under 35 U.S.C. § 119 of Korean Patent Application No. 2004-110609, filed on Dec. 22, 2004, in the Korean Intellectual Property Office, the disclosure of which is incorporated herein in its entirety by reference.

### BACKGROUND OF THE INVENTION

1. Field of the Invention

The present general inventive concept relates to a computer, and more particularly, to a computer capable of switching to a power save mode while downloading data through a network, so that power consumption is reduced.

2. Description of the Related Art

Recently, in accordance with a rapid development of computer and network technology, the use of computers connected with networks, such as the Internet, has been expanded. Particularly, large capacity data is transmitted among computers since the data transmission speed through networks has increased.

A conventional computer capable of transmitting/receiving data through a network, as illustrated in FIG. 1, comprises a central processing unit (CPU) 131, a graphic/memory controller 132, an input/output controller 134, a random access memory (RAM) 133 which is a main memory, a graphic adapter 135, and a network part 110.

The graphic/memory controller 132 manages data transmitted between the random access memory 133 and the graphic adapter 135. The input/output controller 134 manages data transmitted among computer components, such as a hard disk drive 150 and the network part 110, etc., with the exception of the data transmitted between the random access memory 133 and the graphic adapter 135.

The input/output controller 134 comprises a network controller controlling the network part 110 and an IDE (Integrated Drive Electronics) controller managing the hard disk drive 150 therein.

A process performed by the conventional computer having the above described configuration to store downloaded data in the hard disk drive 150 is described as follows.

When the user selects to download a predetermined file via the network (e.g. the Internet, etc.), data corresponding to the selected predetermined file is received through the network part 110. Then, the data received through the network part 110 is temporarily stored in the random access memory 133 via the input/output controller 134 and the graphic/memory controller 132.

Then, an operating system of the conventional computer transmits the data temporarily stored in the random access memory 133 to the hard disk drive 150 via the graphic/memory controller 132 and the input/output controller 134 and controls the hard disk drive 150 to store the data transmitted from the random access memory 133. A network manager and a file manager of the operating system of the conventional computer participate in the process.

However, the network part 110, the input/output controller 134, the graphic/memory controller 132, the random access memory 133, and the hard disk drive 150 participate in the download according to the conventional computer when the user selects to download the data and does not use the computer while the data is downloaded. Also, the operating system and the central processing unit 131 participate in the process to control the hard disk drive 150 to store the predetermined file. Thus, power consumption is large although no other work than the download is performed with the conventional computer.

Also, the conventional computer cannot switch to a power save mode in spite of receiving no input from the user for a long period of time, because the central processing unit 131 and the operating system participate in the process to download the data. Saving power by switching to the power save mode is considered as a critical aspect particularly when the conventional computer is a portable computer which needs to save power as much as possible.

### SUMMARY OF THE INVENTION

The present general inventive concept provides a computer capable of switching to a power save mode while downloading data through a network so that power consumption is reduced.

Additional aspects and/or advantages of the present general inventive concept will be set forth in part in the description which follows and, in part, will be obvious from the description, or may be learned by practice of the general inventive concept.

The foregoing and/or other aspects of the present general inventive concept are achieved by providing a computer comprising a network part to transmit and receive data through a network, a data storage to store downloaded data received through the network part, a mode selector to select one of a first download mode and a second download mode, a first download manager to control the data storage to store the downloaded data received through the network part when the first download mode is selected by the mode selector, and a second download manager to control the data storage to store the downloaded data received through the network part when the second download mode is selected by the mode selector.

The second download manager may be capable of switching to a power save mode when the first download mode is selected by the mode selector.

The second download manager may switch to the power save mode when the power save mode is selected by the mode selector while the first download mode is selected by the mode selector.

The first download manager may comprise a download memory to temporarily store the downloaded data received through the network part, and a second download controller to control the download memory to temporarily store the downloaded data received through the network part and to control the data storage to store the downloaded data temporarily stored in the download memory by a predetermined data unit.

The second download manager may comprise a main memory of the computer, a memory controller to control the main memory, an input/output controller to control the network part and the data storage, and a second download controller to control the memory controller and the input/output controller such that the main memory temporarily stores the downloaded data received through the network part and the data storage stores the downloaded data temporarily stored in the main memory when the second download mode is selected by the mode selector.

The second download controller may further comprise an operating system of the computer, and a central processing unit to load the operating system in the main memory and executing the operating system loaded in the main memory.

The input/output controller may access the data storage through the first download controller of the first download manager.

The computer may further comprise a switching part to link the data storage with the first download controller when the first download mode is selected by the mode selector and to link the data storage with the input/output controller when the second download mode is selected by the mode selector.

The data storage may comprise a hard disk drive divided in a plurality of partitions including a first partition of the hard disk drive to store the downloaded data by the first download manager and a second partition of the hard disk drive separate from the first partition to store the downloaded data by the second download manager.

The foregoing and/or other aspects of the present general inventive concept are also achieved by providing a computer comprising a network part to transmit and receive data through a network, a data storage to store downloaded data received through the network part, a mode selector to select a predetermined download mode, a download manager to control the data storage to store the downloaded data received through the network part when the predetermined download mode is selected by the mode selector, and a controller to control the computer with the exception of the network part, the data storage, and the download manager to switch to a power save mode when the predetermined download mode is selected by the mode selector.

The download manager may comprise a download memory to temporarily store the downloaded data received through the network part, and a download controller to control the download memory to temporarily store the downloaded data received through the network part and to control the data storage to store the downloaded data temporarily stored in the download memory by a predetermined data unit.

The computer may further comprise a main memory, a memory controller to control the main memory, and a input/output controller to control the network part and the data storage, wherein the input/output controller accesses the data storage through the download controller while the predetermined download mode is not selected.

The download manager may control the data storage to store the downloaded data received through the network part in a special partition therein.

The foregoing and/or other aspects of the present general inventive concept are also achieved by providing an electronic device to store and process information comprising one or more components to perform at least one of running executable codes, receiving input signals, outputting data, storing data, and displaying data, an input/output interface to communicate with data sources, a data storage drive, and a download controller to receive downloaded data by the input/output interface from the data sources and to store the downloaded data in the storage drive, wherein the download controller is capable to switch the one or more components to a power save mode.

The foregoing and/or other aspects of the present general inventive concept are also achieved by providing a computer comprising a communication interface connectable to a network to receive and to transmit data, data storage unit to store the data received through the communication interface, a user interface to select one of a first download mode and a second download mode, a first download unit to control the communication interface and the data storage to perform a data download operation when the first download mode is selected, and a second download unit to control the communication interface and the data storage to perform a data download operation when the second download mode is selected, wherein the second download unit is capable of switching to a power save mode when the first download mode is selected.

The foregoing and/or other aspects of the present general inventive concept are also achieved by providing a computer comprising a network interface to download data therethrough, a data storage unit to store data downloaded through the network interface, a direct download mechanism to control the data storage to store data downloaded through the network interface when a direct download mode is selected, and a main computing system connected to the network interface, the data storage and the direct download mechanism, including a plurality of software and hardware components to process data to switch to a power save mode upon selecting the direct download mode.

### BRIEF DESCRIPTION OF THE DRAWINGS

The above and/or other aspects and advantages of the present general inventive concept will become apparent and more readily appreciated from the following description of the embodiments, taken in conjunction with the accompanying drawings of which:

FIG. 1 is a block diagram of a conventional computer;

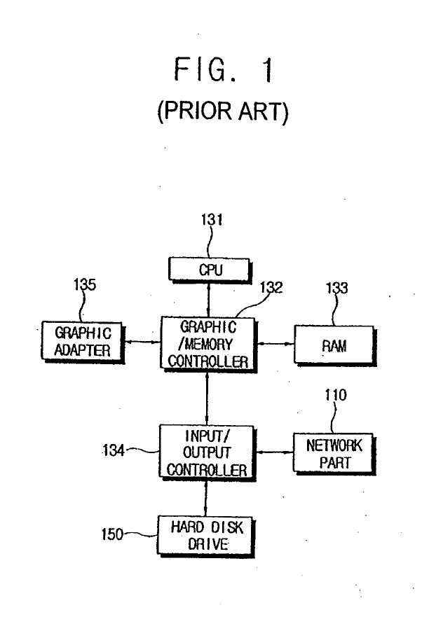

FIG. 2 is a block diagram of a computer according to an embodiment of the present general inventive concept;

FIGS. 3 and 4 are block diagrams detailing structures of a second download manager, a mode selector, and a data storage of the computer illustrated in FIG. 2;

FIG. 4 is a block diagram of a first download manager of the computer illustrated in FIG. 2;

FIG. 5 is a block diagram of a computer according to another embodiment of the present general inventive concept; and

FIG. 6 is a block diagram of a computer according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

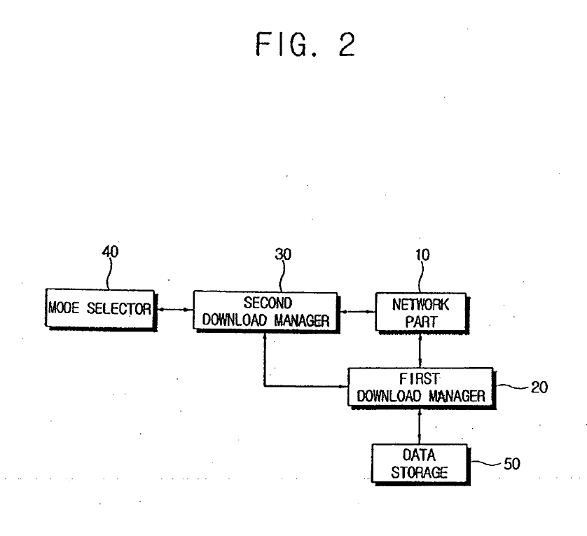

As illustrated in FIG. 2, a computer according to an embodiment of the present general inventive concept comprises a network part 10, a first download manager 20, a second download manager 30, a data storage 50, and a mode selector 40.

The network part 10 transmits and receives data through a network using a predetermined network protocol. The network part 10 may comprise a wireless network part (not shown) and/or a wired network part (not shown).

The wireless network part may comprise a wireless network controller (not shown) and an antenna (not shown). Additionally, the wired network part may comprise a wired network controller (not shown) and a local area network (LAN) connector (not shown), such as a standard phone connector RJ45. The network part 10 transmits and receives data through at least one of various network protocols, such as a Transmission Control Protocol/Internet Protocol (TCP/IP) and an infrared data association (IrDA) protocol.

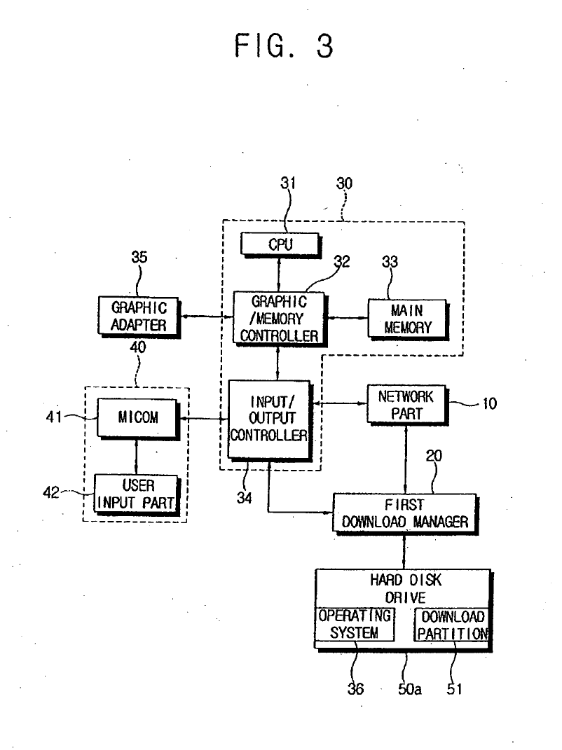

The mode selector 40 outputs a select signal to select one of a first download mode and a second download mode according to a user selection. The mode selector 40 of the present embodiment, as illustrated in FIG. 3, may comprise an user input part 42 to generate a key signal according to the user selection and a microcomputer 41 to output the select signal to select one of the first download mode and the second download mode to the second download manger 30 according to the key signal received from the user input part 42.

The user input part 42 may be a hot key type of a keyboard or may be a combination of two or more of buttons of the keyboard. The user input part 42 may also be a graphic user interface to select one download mode provided by a specific program and an input device, such as the keyboard.

The first download manager 20 controls the data storage 50 to store the downloaded data received through the network part 10 when the first download mode is selected by the mode selector 40.

The second download manger 30 controls the data storage 50 to store the downloaded data received through the network part 10 when the second download mode is selected by the mode selector 40.

The first download manager 20 may comprise a simpler configuration than the second download manager 30. Additionally, the second download manager 30 is capable of switching to a power save mode according to a predetermined condition when the first download mode is selected by the mode selector 40. The power save mode is a feature of a computer component designed to reduce power consumption of the computer components which are not in use. Thus, the user selects the first download mode by the mode selector 40 when the user wants to download a large amount of data through the first download manager 20 and at this time, the second download manager 30 may switch to the power save mode according to the predetermined condition. Accordingly, unnecessary power consumption is minimized when the computer downloads the data without performing other functions.

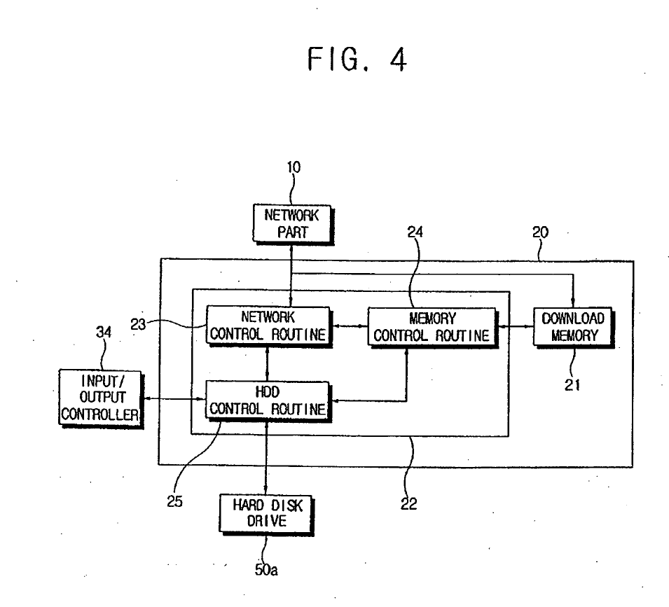

Hereinbelow, the computer according to the present embodiment illustrated in FIG. 2 is described in detail referring to FIGS. 3 and 4. The data storage 50 of FIG. 2 may be embodied as a hard disk drive 50a.

The first download manager 20 according to the present embodiment operates independently of the second download manager 30 and other computer components (i.e. subsystems represented in the block diagrams of FIGS. 2, 3 and 4) of the computer when the first download manager 20 controls the hard disk drive 50a to store the downloaded data received through the network part 10. Thus, the computer components of the computer (e.g. the graphic adapter 35, the mode selector 40, and the second download manager) with the exception of the first download manager 20, the network part 10, and the hard disk drive 50a can switch to the power save mode when the first download manager 20 controls the hard disk drive 50a to store the downloaded data received through the network part 10.

As illustrated in FIG. 4, the first download manager 20 according to the present embodiment may comprise a download memory 21 and a first download controller 22.

The first download controller 22 controls the download memory 21 to temporarily store the downloaded data received through the network part 10. Additionally, the first download controller 22 controls the hard disk drive 20a to store the downloaded data temporarily stored in the download memory 21 by a predetermined data unit. The first download controller 22 may read the downloaded data temporarily stored in the download memory 21 by sector of the hard disk drive 50a and control the hard disk drive 50a to store the downloaded data read from the download memory 21 by sector.

The first download controller 22 may comprise a network control routine 23, a memory control routine 24, and a hard disk drive (HDD) control routine 25.

The network control routine 23 controls a reception/transmission of data between the computer and the network, in particular the reception of the downloaded data received through the network part 10. The network control routine 23 detects the downloaded data among data received through the network part 10 in packets. Additionally, the network control routine 23 may detect whether an error has occurred during transmission of the data received through the network part 10 and may manage the error by requesting retransmission of the data, etc.

The memory control routine 24, as described above, controls the download memory 21 to store and read data in and from the download memory 21, etc. For example, the memory control routine 24 may control the download memory 21 to temporarily store the downloaded data received through the network part 10 and may read the downloaded data temporarily stored in the download memory 21 by sector on the hard disk drive 50a.

The HDD control routine 25 is a control routine to manage the hard disk drive 50a. For example, the HDD control routine 25 may control the hard disk drive 50a to store data or a file and may read the data or the file from the hard disk drive 50a. The HDD control routine 25 may be coupled with an input/output controller 34 of the second download manager 30 and may relay an access from the input/output controller 34 to the hard disk drive 50a in the second download mode.

The hard disk drive 50a according to the present embodiment may be divided into a plurality of partitions. Also, the HDD control routine 25 of the first download controller 22 may control the hard disk drive 50a to store the downloaded data received through the network part 10 in a partition (e.g. a download partition 51 illustrated in FIG. 3) which may be different from a partition storing the downloaded data according to control of the second download manager 30 in the second download mode. Thus, the downloaded data may be stored in the hard disk drive 50a by sector by a file management function of the HDD control routine 25 which is a minimized version of a function of a file manager of an operating system 36. Then, the operating system 36 may read the downloaded data stored in the download partition 51 and may write the downloaded data read from the download partition 51 in another partition such as a partition to be managed by the file manager of the operating system 36.

Referring to FIG. 3, the second download manager 30 according to the present embodiment may comprise a central processing unit (CPU) 31, a graphic/memory controller 32, a main memory 33 and the input/output controller 34.

The graphic/memory controller 32 may be a chipset to manage data transfer among the central processing unit 31, the main memory 33 and a graphic adapter 35. The graphic/memory controller 32 may comprise a memory control routine to control the main memory 33 and a graphic control routine to control the graphic adapter 35. A graphic memory control hub (GMCH) of INTEL CORP may be used as the graphic/memory controller 32.

The main memory 33 may comprise a random access memory (RAM) which is a non volatile memory and may temporarily store the operating system 36, an application program, data, etc, which may be executed by the central processing unit 31.

The input/output controller 34 may manage data transmitted among the mode selector 40, the network part 10 and the graphic/memory controller 32. Additionally, the input/output controller 34 may access the hard disk drive 50a through the download controller 22 of the first download manager 20 and write/read the downloaded data, other data or a file to/from the hard disk drive 50a during the second download mode.

Meanwhile, the second download manager 30 according to the present embodiment may comprise the operating system 36 stored in the hard disk drive 50a. The central processing unit 31 may load the operating system 36 stored in the hard disk drive 50a to the main memory 33 and may execute routines of the operating system 36 loaded in the main memory 33. The operating system 36 may comprise the file manager to read/write data from/to the hard disk drive 50a and a network manager to manage data and to receive/transmit data through the network part 10. The network manager may be coupled with a network driver to control the network part 10 and may manage communication of the computer with the network.

Moreover, the second download manager 30 according to the present embodiment may transfer a control authority of downloading to the first download manager 20 according to the select signal received from the mode selector 40. The input/output controller 34 may receive the select signal from the mode selector 40 when the user selects the first download mode through the mode selector 40. Then, the operating system 36 controls the second download controller 32 to transfer the control authority of downloading the downloaded data through the network part 10 to the first download controller 22 based on the select signal received from the input/output controller 34. The select signal received by the input/output controller 34 may be transmitted to a basic input output system (BIOS) (not shown). Then, the control authority of downloading the data is transferred to the first download controller 22 by the basic input output system.

Hereinbelow, a process in which the second download manager 30 controls the hard disk drive 50a to store the downloaded data received through the network part 10 in the second download mode is described.

The downloaded data received through the network part 10 may be temporarily stored in the main memory 33 via the input/output controller 34 and the graphic/memory controller 32. At this time, the network manager and the network driver of the operating system 36 may detect an error related to the downloaded data received as a data packet and may request retransmission of the downloaded data in the data packet. Then, the file manager of the operating system 36 may read the downloaded data temporarily stored in the main memory 33 by data units capable of being stored in the hard disk drive 50a and controls the hard disk drive 50a to store the downloaded data read from the main memory 33 via the graphic/memory controller 32 and the input/output controller 34. In this case, the input/output controller 34 may access the hard disk drive 50a through the first download controller 22 of the first download manager 20.

The second download manager 30 according to the present embodiment may switch to the power save mode when the first download mode is selected through the mode selector 40. Accordingly, the operating system 36 may control the computer with the exception of the first download manager 20, the network part 10, and the hard disk drive 50a to switch to the power save mode when the predetermined condition, such as no input from an input device (not shown) during a predetermined period, is satisfied.

Also, the operating system 36 may control the computer with the exception of the first download manager 20, the network part 10, and the hard disk drive 50a to switch to the power save mode when a signal corresponding to a command to switch to the power save mode is input through the mode selector 40 in the first download mode, regardless whether the predetermined condition is satisfied. Accordingly, the user may select the first download mode and the power save mode through the mode selector 40 when the user wants the computer to perform only the downloading.

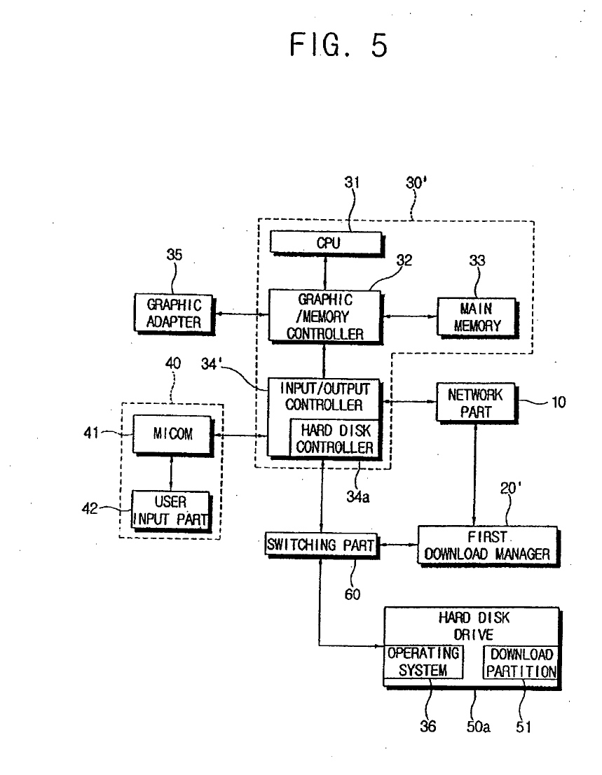

A computer according to another embodiment of the present general inventive concept is described in detail while referring to FIG. 5. Here, like reference numerals as in the previous embodiment description refer to like elements throughout, and repetitive descriptions will be avoided.

The computer according to the embodiment in FIG. 5 comprises a switching part 60 to connect a hard disk drive 50a to one of a first download manager 20′ and a second download manager 30′. An input/output controller 34′ of the second download manager 30′ may comprise a hard disk controller to control the hard disk drive 50a.

The switching part 60 may connect the hard disk drive 50a to a first download controller 22 of the first download manager 20′ when a first download mode is selected through a mode selector 40. Thus, the first download controller 22 can access the hard disk drive 50a in the first download mode.

On the other hand, the switching part 60 may connect the hard disk drive 50a to an input/output controller 34′ of the second download manager 30′ when a second download mode is selected through the mode selector 40. Thus, the input/output controller 34′ can access the hard disk drive 50a in the second download mode.

According to the present embodiment illustrated in FIG. 5, the input/output controller 34′ of the second download manager 30′ accesses the hard disk drive 50a directly and not via the first download controller 22 of the first download manager 20′ as described in the previous embodiment.

The switching part 60 may be switched by a micom 41 of the mode selector 40 or by the input/output controller 34′ of the second download manager 30′.

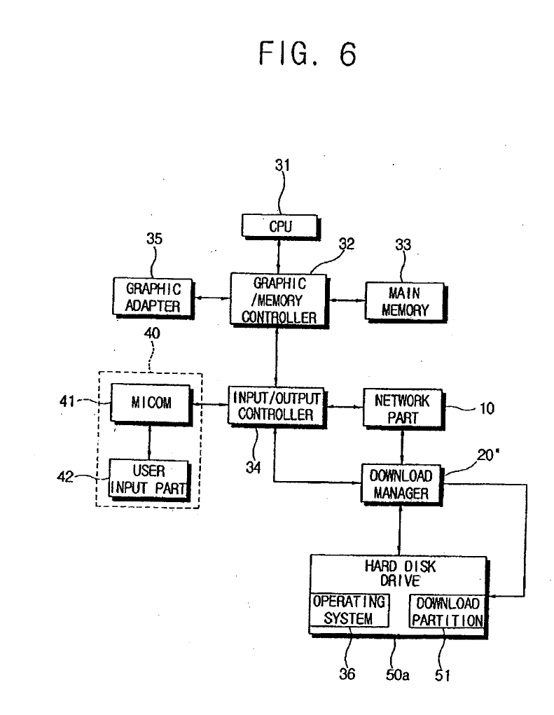

A computer according to another embodiment of the present general inventive concept is described in detail while referring to FIG. 6. Here, like reference numerals as to the previous embodiments refer to like elements throughout, and repetitive descriptions will be avoided.

As illustrated in FIG. 6, the computer according to the present embodiment comprises a network part 10 to transmit/receive data through a network, a hard disk drive 50a which is a data storage 50a (e.g. a hard disk driver) to store the downloaded data received through the network part 10, and a mode selector 40 to select a predetermined download mode.

Also, the computer according to the present embodiment comprises a download manager 20″ to control the data storage 50a to store the downloaded data received through the network part 10 and a controller to control data transfer in the computer components with the exception of the network part 10, the data storage 50, and the download manager 20″ to switch to a power save mode when the predetermined download mode is selected by the mode selector 40. The controller according to the present embodiment comprises an operating system 36 to control the computer to switch to the power save mode according to a select signal from the mode selector 40.

That is, the download manager 20″ controls the data storage 50a to store the downloaded data received through the network part 10. Then, the operating system 36 controls the computer components (e.g. the graphic/memory controller 32, the main memory 33, the graphic adapter 35, and the input/output controller 34)with the exception of the network part 10, the data storage 50a, and the download manager 20″ to switch to the power save mode when the user selects the download mode while the downloaded data is received through the network part 20.

The micom 41 of the mode selector 40 notifies the input/output controller 34 that the download mode is selected through the mode selector 40. Then, the operating system 36 may control the computer to switch to the power save mode when the selection of the download mode is notified from the input/output controller 34 to the operating system 36 via the graphic/memory controller 32.

Accordingly, the downloaded data received through the network part 10 is stored in the hard disk drive 50a by the download manager 20″. Then, unnecessary power consumption is minimized since the computer components with the exception of the computer components participating in downloading switch to the power save mode when the user selects the download mode through the mode selector 40.

The first download manager 20′ according to the previous embodiment and the download manager 20″ according to the present embodiment (as described above) may have a same configuration as the download manager 20 illustrated in FIG. 4.

The download memory 21 of the first download manager 20 as illustrated in FIG. 4 may be provided as a special chip, such as a type of random access memory (RAM). The download memory 21 may also be a buffer or a cache memory provided in the download manager 20.

The switching part 60 according to the previous embodiment illustrated in FIG. 5 may be used in the computer according to the present embodiment.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A computer comprising:
a network part to transmit and receive data through a network;
a data storage to store downloaded data received through the network part;
a mode selector to select one of a first download mode and a second download mode;
a first download manager to control the data storage to store the downloaded data received through the network part when the first download mode is selected by the mode selector; and
a second download manager to control the data storage to store the downloaded data received through the network part when the second download mode is selected by the mode selector.

2. The computer according to claim 1, wherein the second download manager is capable of switching to a power save mode when the first download mode is selected by the mode selector.

3. The computer according to claim 2, wherein the second download manager switches to the power save mode when the power save mode is selected by the mode selector while the first download mode is selected by the mode selector.

4. The computer according to claim 2, wherein the first download manager comprises:
a download memory to temporarily store the downloaded data received through the network part; and
a first download controller to control the download memory to temporarily store the downloaded data received through the network part and to control the data storage to store the downloaded data temporarily stored in the download memory by a predetermined data unit.

5. The computer according to claim 1, wherein the second download manager comprises:
a main memory of the computer;
a memory controller to control the main memory;
an input/output controller to control the network part and the data storage; and
a second download controller to control the memory controller and the input/output controller such that the main memory temporarily stores the downloaded data received through the network part and the data storage stores the downloaded data temporarily stored in the main memory when the second download mode is selected by the mode selector.

6. The computer according to claim 5, wherein the second download controller further comprises:
an operating system of the computer; and
a central processing unit to load the operating system in the main memory and to execute the operating system loaded in the main memory.

7. The computer according to claim 5, wherein the input/output controller accesses the data storage through the first download controller of the first download manager.

8. The computer according to claim 5, further comprising:
a switching part to link the data storage with the first download controller when the first download mode is selected by the mode selector and to link the data storage with the input/output controller when the second download mode is selected by the mode selector.

9. The computer according to claim 5, wherein the data storage comprises:
a hard disk drive divided in a plurality of partitions including a first partition of the hard disk drive to store the downloaded data from the first download manager and a second partition of the hard disk drive separate from the first partition to store the downloaded data from the second download manager.

10. A computer comprising:
a network part to transmit and receive data through a network;
a data storage to store downloaded data received through the network part;
a mode selector to select a predetermined download mode;
a download manager to control the data storage to store the downloaded data received through the network part when the predetermined download mode is selected by the mode selector; and
a computer controller to control the computer with the exception of the network part, the data storage, and the download manager to switch to a power save mode when the predetermined download mode is selected by the mode selector.

11. The computer according to claim 10, wherein the download manager comprises:
a download memory to temporarily store the downloaded data received through the network part; and
a download controller to control the download memory to temporarily store the downloaded data received through the network part and to control the data storage to store the downloaded data temporarily stored in the download memory by a predetermined data unit.

12. The computer according to claim 11, further comprising:
a main memory;
a memory controller to control the main memory; and
an input/output controller to control the network part and the data storage, wherein the input/output controller accesses the data storage through the download controller while the predetermined download mode is not selected.

13. The computer according to claim 12, wherein the download manager controls the data storage to store the downloaded data received through the network part in a special partition therein.

14. An electronic device to store and process information, comprising:
one or more components to perform at least one of running executable codes, receiving input signals, outputting data, storing data, and displaying data;
an input/output interface to communicate with data sources;
a data storage drive; and
a download controller to receive downloaded data through the input/output interface from the data sources and to store the downloaded data in the storage drive, wherein the download controller is capable of switching the one or more components to a power save mode.

15. The electronic device according to claim 14, wherein the download controller switches the one or more components to the power save mode when a first download mode is input from the one or more components.

16. The electronic device according to claim 14, wherein the download controller switches the one or more components to the power save mode when a second download mode is input from the one or more components and a predetermined condition is satisfied.

17. The electronic device according to claim 16, the condition is that the one or more components are idle for a predetermined period.

18. The electronic device according to claim 14, wherein the one or more components comprise a combination of a display, a keyboard, a touch-screen, a keypad, a graphic interface, a main memory and a CPU.

19. A computer, comprising:
a communication interface connectable to a network-to receive and to transmit data;
a data storage unit to store the data received through the communication interface;
a user interface to select one of a first download mode and a second download mode;
a first download unit to control the communication interface and the data storage to perform a data download operation when the first download mode is selected; and
a second download unit to control the communication interface and the data storage to perform the data download operation when the second download mode is selected, wherein the second download unit is capable of switching to a power save mode when the first download mode is selected.

20. The computer according to claim 19, wherein the second download unit is connected to the data storage unit through the first download unit.

21. The computer according to claim 19, further comprising:
a connector to connect the first download unit to the data storage unit when the first download mode is selected.

22. A computer, comprising:
a network interface to download data therethrough;
a data storage unit to store data downloaded through the network interface;
a direct download mechanism to control the data storage to store data downloaded through the network interface when a direct download mode is selected; and
a main computing system connected to the network interface, the data storage and the direct download mechanism, including a plurality of software and hardware components to process data and to switch to a power save mode upon selecting the direct download mode.

23. The computer according to claim 22, wherein the direct download mechanism comprises:
a buffer memory to temporary store the data downloaded through the network interface; and
a data transfer controller to transfer the downloaded data stored in the buffer memory to the data storage unit by a predetermined amount of data when downloading data is complete.

24. The computer according to claim 23, wherein the data transfer controller submits a download report including location information of the downloaded data stored in the data storage to the main computing system when downloading data is complete.
